(19) United States
(12) Patent Application Publication
(10) Pub. No.: US 2014/0333773 A1
(43) Pub. Date: Nov. 13, 2014

(54) PORTABLE AUDIO/ VIDEO MASK

(71) Applicants: Randy James Davis, Angels Camp, CA (US); Larry James Davis, Angels Camp, CA (US); Brian Edward Bates, Angels Camp, CA (US)

(72) Inventors: Randy James Davis, Angels Camp, CA (US); Larry James Davis, Angels Camp, CA (US); Brian Edward Bates, Angels Camp, CA (US)

(21) Appl. No.: 14/256,943

(22) Filed: Apr. 19, 2014

Related U.S. Application Data
(60) Provisional application No. 61/822,320, filed on May 11, 2013.

(51) Int. Cl. H04N 5/225; G08C 17/02; G06F 3/0354; H04R 1/02; G02B 27/01; G09G 3/32

(52) U.S. Cl. CPC H04N 5/2252; G02B 27/0172; G02B 27/0176; G09G 3/3208; G06F 3/03543; H04R 1/028; G08C 17/02; G02B 2027/0159; H04R 2201/023; G09G 2354/00; G08C 2201/00
USPC 348/158

(57) ABSTRACT

A portable electronic device comprises a mask having a front surface, a right surface, a left surface and a back surface. A pair of organic light-emitting (OLED displays) is provided with high resolution and auto focus adjustment. A micro digital camera lens at the front surface of the mask provides vision without removing the mask. The micro digital camera lens is turned to night vision mode to provide visibility during dark conditions. A pair of headphones is in communication with the PCB module and a power switch is used to turn on and turn off the PCB module of the pair of OLED displays. A pair of headgear knobs is used to allow the adjustment and removal of the mask. The mask is designed to provide high quality audio/visual capabilities with comfort and privacy. The device also provides audio/visual experience that intends to be free from radiation and vertigo.

### RELATED APPLICATIONS

This application claims priority from the U.S. provisional application with Ser. No. 61/822,320 filed on May 11, 2013. The disclosure of the provisional application is incorporated herein as if set out in full.

### BACKGROUND OF THE DISCLOSURE

1. Technical Field of the Disclosure

The present disclosure is related in general to portable electronic devices used for entertainment and education and in particular to an electronic device for providing audio and video information of high quality to a user in a private environment.

2. Description of the Related Art

Information processing, sound recording, electronic recording of sound and images, electronic communications and electronic entertainment systems have become wide spread with portable applications of these technologies growing rapidly. In recent years, various kinds of audio and video portable electronic devices are in use and available for sale. In certain devices, it is not possible to enjoy both audio and video simultaneously. In the case of some video devices, providing a large screen for display can cause low quality audio. Accordingly there is a demand for a portable device that allows both high quality audio and video to be played simultaneously. In prior devices, displays are limited by their resolution, size and weight and hence these are placed at a larger distance from the eye. These displays have low resolution and are not capable of focusing automatically.

Learning disabilities affect the way we take in and process information. The most common types of assistive technologies used by people with learning disabilities are focused around reading, language, organizational skills, and processing information. Some assistive technologies include screen readers, alternative keyboards, head-pointing devices, voice recognition software, and screen magnification software. Attention-deficit hyperactivity disorder (A.D.H.D.) is a common neurobiological disorder that can be noticed in the preschool or early grades of school. A.D.H.D. affects between 5-12% of the population or about 1 or 2 students in every classroom. People suffering from these disorders fail to complete tasks and have difficulty switching to other tasks. They fail to remember sequence of activities to be performed. Many technologies are available today that can help students to cope with their learning disabilities. To effectively use the technology, the teacher and programming team should understand the nature of the learning disability through assessment and diagnosis. However, technological tools assist a student only if the tool matches the student's need.

Conventional portable electronic devices used for entertainment and education have considerable drawbacks. For example, these devices do not provide high quality sound and picture. Many previous devices used an expensive and heavy series of optical elements to obtain a high quality picture. In many devices, high viewing angles resulted in poor image contrast. These devices lack quality images in order to mask off unwanted light near the edge of an image generator. These devices do not provide assistance for students in real-time, real classroom and real world learning. These devices do not provide noise reduction and are not free from vertigo.

One of the existing portable electronic devices currently in use includes a head mounted display comprising a display device, a head mount, noise reduction devices, and a speaker. The display device is coupled to the head mount and produces visual images based on received video signals. The head mount is mounted on the user's head and is coupled to the noise reduction devices, which cover the user's ears such that external noise is reduced. The noise reduction devices are coupled together via a strap that fits around the user's head. The noise reduction devices are coupled to and house speakers that produce sound signals based on received audio signals. As a result, the user may see the video images produced by the display device and clearly hear the sounds produced by the speaker, and the external noise heard by the user is reduced. However, this device does not provide screen sharing and the capability real-time communication and learning.

Another existing portable electronic device discloses a visual display device provided for delivering a generated image, preferably combinable with environment light, to the eye of a user. The device is lightweight and compact and yields a high quality image. In one embodiment, a shroud protects the eyes from stray light and holds optical elements in desired alignment. In one embodiment an image generator is masked by at least two masks to provide for a high quality image without waste. In one embodiment, a removable mounted shield or other device can convert the apparatus from a see-through device to an immersion device and back again. In one embodiment, the device can be comfortably mounted to the user's head while still allowing for the use of conventional eyeglasses. A tracker for outputting an indication of the orientation, attitude and/or position of a head-mounted display (HMD) may be provided. The tracker can be configured so that it is incorporated in the HMD housing and/or can be easily decoupled from the HMD, so that the HMD can be used without the tracker (e.g. for watching movies). In one embodiment, the tracker uses magnetic sensors. In another embodiment, one or more inertial sensors, such as a rate gyro and/or accelerometers are used. The device does not provide high quality video and audio effects free from radiation and vertigo.

Another existing portable electronic device discloses a head-mounted visual display apparatus for displaying an image generated by an image generator to a wearer of the apparatus. The visual display apparatus comprises a helmet comprising a shell and a headband engaged to an interior surface of the shell; an adjustment mechanism mounted to an exterior surface of the helmet for adjusting the size of the headband; and a video display housed within the helmet and connected to the image generator for displaying the image. In a preferred embodiment the adjustment mechanism includes a knob mounted on an exterior surface of the shell and connected to the headband by a rotatable shaft disposed through the shell between the knob and the headband.

The prior devices all suffer from one or more disadvantages. Therefore, there is a need for a system that would provide both entertainment and educational facility with comfort and privacy. Such a needed device would provide both a high quality sound and picture. The device would also provide opportunities for students having learning disorders to focus on educational activities without external distractions. The device would offer real time learning and provide a regular classroom accommodation. Further, the device would be free from radiation and vertigo. The present invention overcomes prior art shortcomings by accomplishing these critical objectives.

### SUMMARY OF THE DISCLOSURE

To minimize the limitations found in the prior art and to minimize other limitations that will be apparent upon the reading of the specifications, the preferred embodiment of the present invention provides a device for providing education and entertainment for a user in a comfortable and private environment and discloses in detail a portable electronic device with audio and video effects with high quality. The device is primarily intended for providing entertainment and education for the user without external distractions.

The present invention provides a portable electronic device for providing audio/video information in a private environment. The portable electronic device comprises a mask having a front surface, a right surface, a left surface and a back surface. A pair of high-resolution organic light-emitting diode displays (“OLED displays”) is incorporated at the back surface of the mask. The pair of OLED displays is provided with high resolution and auto focus adjustment. The pair of OLED displays may remain transparent when the system is not in use. The pair of OLED displays, which are each electronically tinted, turns dark when the portable electronic device is in use and videos are projected on an inner surface of the mask thereby cutting the transparency and allowing the user to use the display inside the helmet. A fish eye lens is used capture to capture wide field of view for the user to see on the pair of OLED displays. A micro digital camera lens at the front surface of the mask provides vision without removing the mask. The micro digital camera lens can be turned to night vision mode to provide visibility in dark conditions. The mask touches the top of the forehead, ears, and back of the head of a user but does not touch anywhere on the user's face. A front facing camera on the mask allows viewing a real-time video on the pair of OLED displays to the user and allows the user to see ahead of the user on the pair of OLED displays.

In one embodiment, a backward facing second camera can allow the user to see behind the user wearing the mask. A touchpad is embedded at the front surface of the mask for cursor/mouse control. The touchpad allows the user to control in real time and with 1:1 movement where the mouse is on the screen. A built-in wireless Bluetooth mouse is enabled allowing the user to use a mouse on a desk or the touch to control a cursor displayed on the pair of OLED displays. In other alternative embodiments, the OLED display may be replaced with a liquid crystal display (LCD).

The mask includes at least one built-in air vent with filter that allows the circulation of air inside the mask. A lightweight blower is positioned at the back surface of the mask to draw fresh exterior air across the interior of the mask and exhaust air outside the mask. A blower switch is used to turn on and turn off the blower. A wireless remote is used to control the pair of OLED displays, color saturation, focus, clarity, contrast, 2D-3D mode, brightness, hue, volume, downloading videos and online streaming of videos. A printed circuit board (PCB) module has a built-in memory available in 8 GB, 16 GB and 32 GB that works with the USB port or Wi-Fi for downloading videos from the internet, smart phones or personal computers.

Each of the pair of OLED displays used in the device may be a curved display. In the photography mode, the user can zoom in and zoom out using the controls on the device. The face fitment of the device is modeled after an average face as computed from over 50 ethnicities of faces. An exciter and a flat panel speaker or alternatively a traditional speaker are used for producing sound. High definition multimedia interface (HDMI) output or TOSHIBA LINK (TOSLINK) connect is used in the device. The portable electronic device operates via the Android operating system. A charging pad is used for charging the mask through induction. The portable electronic device also uses a 3-axis accelerometer to measure head tracking for movies. The portable electronic device uses a wireless storage allowing the user to synchronize/download videos to/from smart phones, tablets, game consoles, hand-held games, (MP3), 4&5 players, personal computers etc.

The mask comprises a pair of headphones that is in wired or wireless communication with the PCB module. A power switch is used to turn on and turn off the pair of OLED displays and the PCB module. In one embodiment, an audio/video port (not shown) may be connected to PCB module (not shown) which allows the user to play or view movies, video games, instructional or educational videos, online books, meditation videos, etc. through an audio/video cable plugged into devices with compatible audio or video output sources. The devices are also connected using Wi-Fi, Bluetooth or video streaming applications of devices such as smart phones, tablets, game consoles, hand-held games, Media Player3 (MP3), 4&5 players, personal computers etc. A plurality of lithium ion batteries that are rechargeable are used for powering the PCB module and the pair of OLED displays. The mask further incorporates a built-in wireless microphone that allows verbal communication without removing the mask. A headgear with a pair of headgear knobs at the left surface and the right surface of the mask allows adjustment for head size, flipping-up in lieu of total removal of the mask, and removal of mask. A headgear pad is used for securing the headgear in position without causing dislocation of the headgear. Further, a blower cover located at the back surface of the mask to provide protective covering for the blower.

A first objective of the present invention is to provide a device that includes eye tracking i.e. the movement on the display adjusts up and down with eye movement.

A second objective of the present invention is to provide a device that includes wireless mirroring as a means for getting the signal from a mobile phone or a tablet into the mask.

A third objective of the present invention is to provide a device that loses and regains its transparency depending on electricity flow and allows the display to appear transparent when the device is turned off.

A further object of the present invention is to provide a device that includes a motion actuator for games.

A further objective of the present invention is to provide a device that allows verbal communication with other online users without removing the device.

A further object of the present invention is to provide educational assistance for people with learning disorders such as Attention Deficit Disorders (ADD) and Attention Deficit Hyperactivity Disorder (ADDH).

A final objective of the present invention is to provide a device that would help in the management of personal behavior of students in educational institutions.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a side perspective view of a preferred embodiment of a portable electronic device illustrating a mask with a wireless remote;

FIG. 2 is a side transparent view of the preferred embodiment of the mask of the portable electronic device;

FIG. 3 is a front view of the of the preferred embodiment of the mask worn by a user;

FIG. 4 is side transparent view of the preferred embodiment of the mask;

FIG. 5 illustrates a front transparent view of the preferred embodiment of the portable electronic device;

FIG. 6A illustrates a first view of a curved OLED display; and

FIG. 6B illustrates a first view of a curved diode OLED display.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

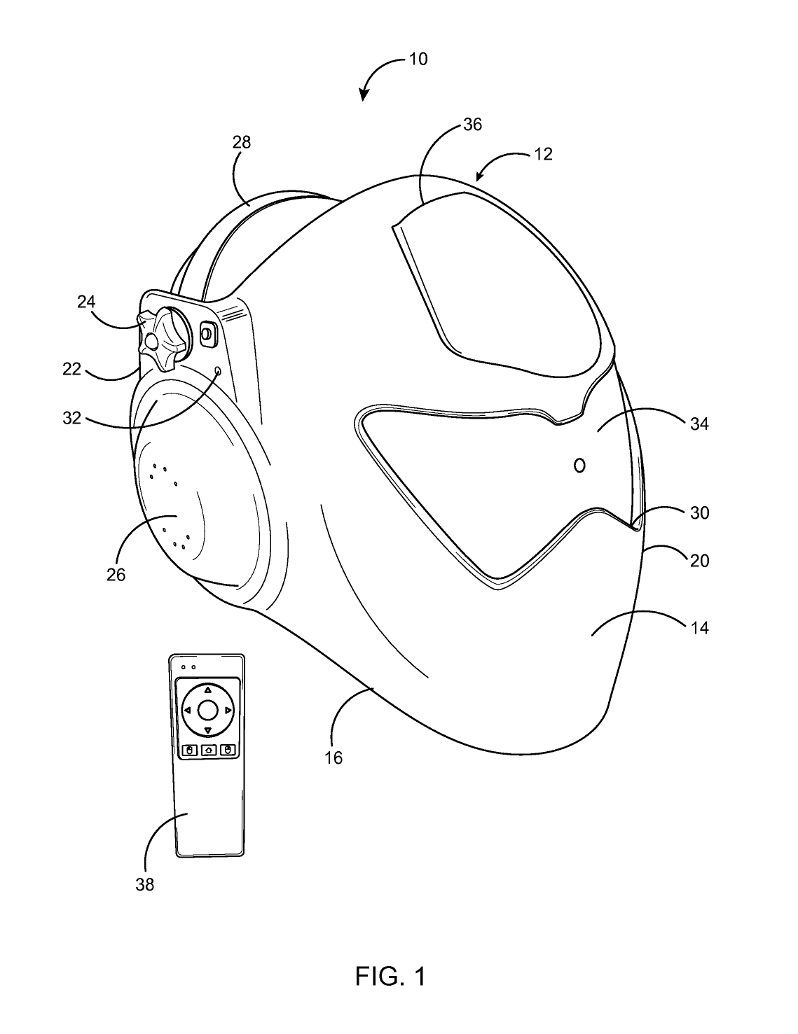

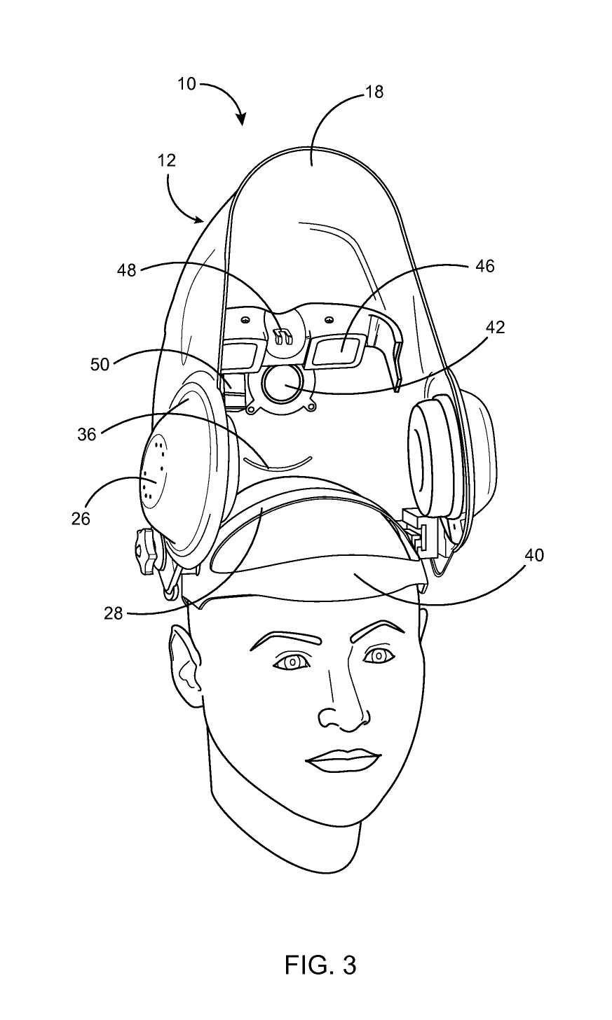

FIG. 1 is a side perspective view of a preferred embodiment of a portable electronic device 10 illustrating a mask 12 with a wireless remote 38. The mask 12 having a front surface 14, a right surface 20, a left surface 22, and a back surface 18 (see FIG. 3). The mask 12 comprises a pair of high-resolution OLED displays 46 (see FIG. 3) with auto focus adjustment. There is at least one built-in air vent 36 at the front surface 14 of the mask 12 to provide supply of air at the back surface 18 of the mask 12. The air vent preferably includes a filter (not shown) for filtering outside air. A headgear 28 which is lightweight and adjustable and a pair of headgear knobs 24 are included that allow the adjustment and removal of the mask 12. A wireless microphone 48 (see FIG. 3) to allow verbal communication without removal of the mask 12. A micro digital camera lens 30 at the front surface 14 of the mask 12 provides vision outside the mask 12 without removal of the mask 12. The micro digital camera lens 30 is adaptable to be turned to night vision mode. The pair of OLED displays 46 (see FIG. 3) may remain transparent when the system is not in use. The pair of OLED displays 46, which is electronically tinted, turns dark when the portable electronic device 10 is in use and videos are projected on an inner surface of the mask 12 thereby cutting the transparency and allowing the user to use the pair of OLED displays 46 inside the mask 12. A fish eye lens (not shown) is used to capture a wide field of view for the user to see on the pair of OLED displays 46 (see FIG. 3). The micro digital camera lens 30 on the mask 12 allows viewing a real-time video on the pair of OLED displays 46 to the user and allows the user to see ahead of the user on the pair of OLED displays 46. The mask 12 touches the top of the forehead, ears, and back of the head of a user but does not touch anywhere on the user's face. The wireless remote 38 is used to control the pair of OLED displays 46, color saturation, focus, clarity, contrast, 2D-3D mode, brightness, hue, volume, downloading videos and online streaming of videos.

In one embodiment, a second backward facing second camera (not shown) allows the user to see behind the user wearing the mask 12. A touch pad 34 in one embodiment is embedded at the front surface 14 of the mask 12 for cursor control. The touchpad 34 allows the user to control in real time and with 1:1 movement where the cursor is on the screen. If the user points to the center of the front of the mask, the cursor will be in the center of the display. If the user slides his finger from that center position to a right position then the cursor moves accordingly to the right. A built-in wireless Bluetooth mouse is enabled allowing the user to use a mouse on a desk or the touch to control a cursor displayed on the pair of OLED displays 46 via the touch pad 34 embedded at the front surface 14 of the mask 12. A power switch 32 is incorporated to turn on and turn off the pair of OLED displays 46 and a PCB module (not shown).

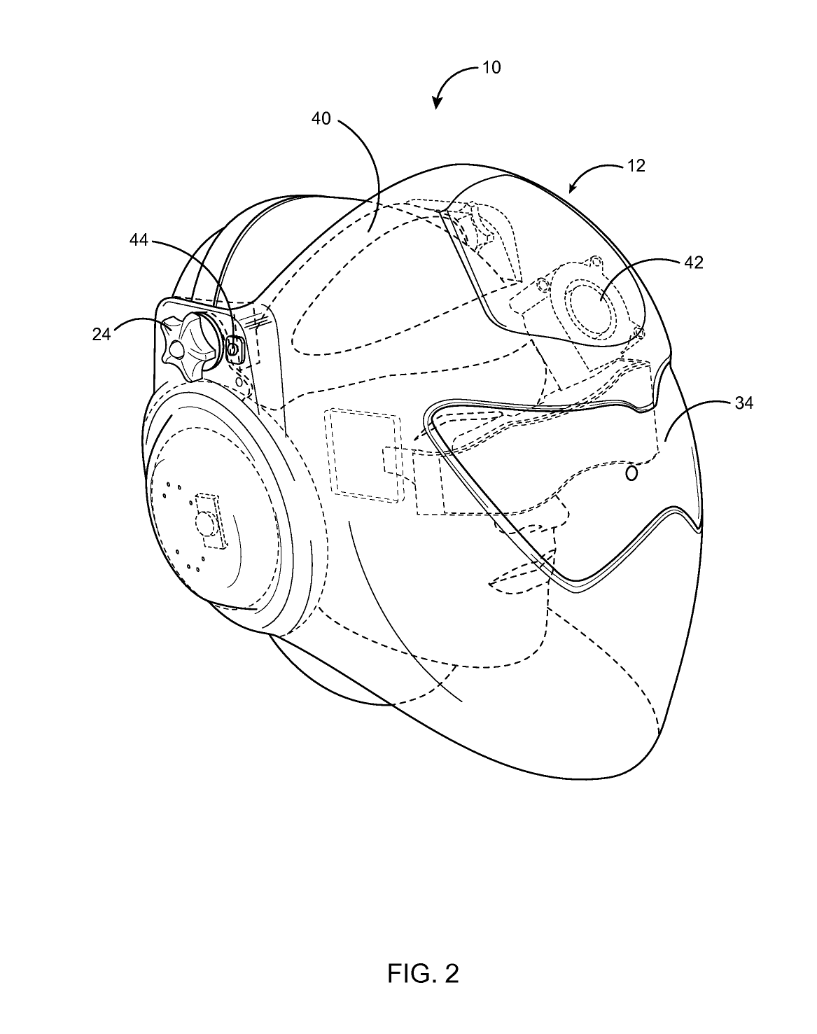

Referring to FIG. 2, a side transparent view of the preferred embodiment of the mask 12 of the portable electronic device 10 is illustrated. When the mask 12 is turned completely off, the pair of OLED displays 46 (see FIG. 3) may be essentially transparent. A pair of headgear knobs 24 is used to allow the adjustment and removal of the mask 12. A blower 42 on the back surface 18 (see FIG. 3) of the mask 12 to allow circulation of exterior air across the back surface 18 of the mask 12 through the at least one built-in air vent 36 (see FIG. 1). A blower switch 44 on the right surface 20 (see FIG. 1) of the mask 12 is provided to turn on and turn off the blower 42.

Referring to FIG. 3, a front view of the preferred embodiment of the mask 12 worn by a user is shown. The PCB module (not shown) is incorporated which has built-in memory available in 8 GB, 16 GB and 32 GB and may be used to control among other things the display. The PCB module (not shown) works with a USB port or with Wi-Fi for downloading or streaming movies from the Internet, smart phones or personal computers. The PCB module (not shown) and the pair of OLED displays 46 include a plurality of lithium ion batteries 50 with a USB charger. The PCB module (not shown) is air cooled by virtue of the lightweight blower 42 and the at least one built-in air vent 36. A headgear pad 40 is used for securing the headgear 28 in position without causing dislocation of the headgear 28. The invention comprises a pair of headphones 26 that is in wired or wireless communication with the PCB module (not shown). Preferably, to save weight a wired connection is employed, however, in alternative embodiments the system may rely on wireless communication such as Wi-Fi or Bluetooth.

In one embodiment, an audio/video port (not shown) may be connected to PCB module (not shown) which allows the user to play or view movies, video games, instructional or educational videos, online books, meditation videos, etc. through an audio/video cable plugged into devices with compatible audio or video output sources. The devices are also connected using Wi-Fi, Bluetooth or video streaming applications of devices such as smart phones, tablets, game consoles, hand-held games, Media Player3 (MP3), 4&5 players, personal computers etc.

The at least one built-in air vent 36 at the front surface 14 (see FIG. 1) of the mask 12 provides circulation of fresh exterior air to the back surface of the mask 12. The wireless microphone is built into the PCB display system to allow verbal communication. The wireless microphone 48 is adaptable to allow other online communication without the removal of the mask 12. The mask 12 further comprises the plurality of rechargeable lithium ion batteries 50 with USB charger for powering the pair of OLED displays 46 and the PCB module (not shown).

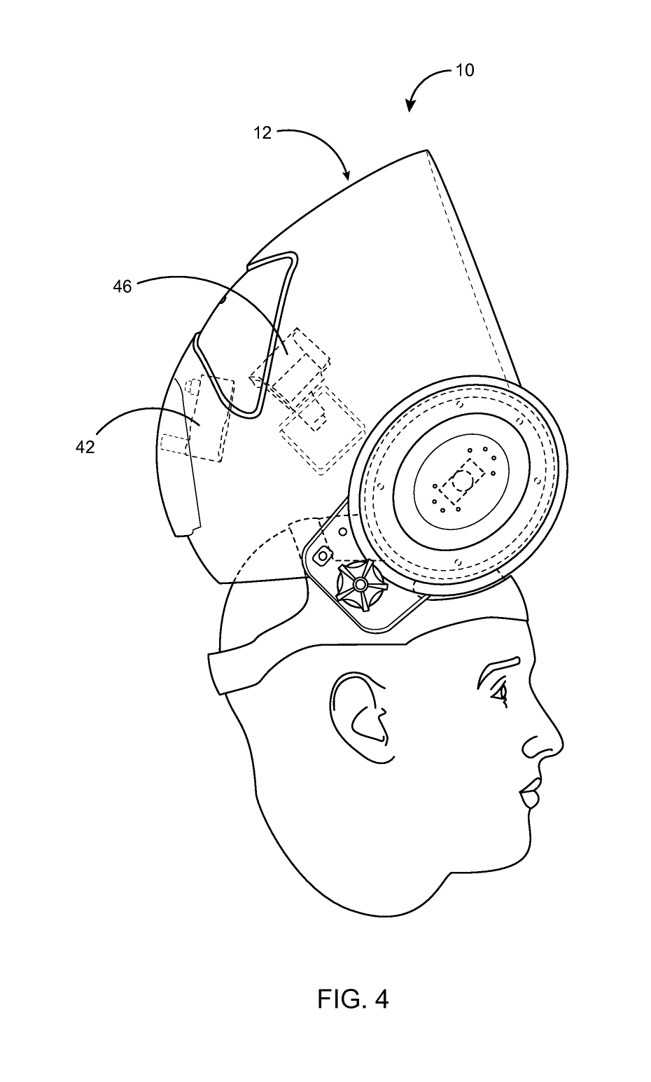

FIG. 4 is side transparent view of the preferred embodiment of the mask 12. A lightweight blower 42 is positioned at the back surface 18 (see FIG. 3) of the mask 12 to draw fresh air across the interior of the mask 12 and used air out of the mask 12.

The portable electronic device 10 uses a wireless storage allowing the user to synchronize/download videos to/from devices such as smart phones, tablets, game consoles, hand-held games, (MP3), 4&5 players, personal computers etc. the device provides screen sharing where a user can share what he is seeing on the pair of OLED displays 46 with another user nearby who is wearing one of the masks.

The pair of OLED displays 46 used in the device may be a curved display. The user can zoom in and zoom out using the controls on the device in the photography mode. In alternative embodiments of the invention, the user may zoom in and out of the real-time display received from the forward facing camera micro digital camera lens 30. The face fitment of the device 10 is modeled after an average face as computed from over 50 ethnicities of faces. An exciter and a flat panel speaker rather than a traditional speaker are used for producing sound, although in an alternative embodiment of the invention a traditional speaker may be used. High definition multimedia interface (HDMI) output or TOSHIBA LINK (TOSLINK) connect are used in the device. The portable electronic device operates via the Android operating system. A charging pad is used for charging the mask 12 through induction. The portable electronic device 10 also uses a 3 axis accelerometer to measure head tracking for movies, which means that with a larger display inside the device 10 can automatically move the display of a movie from side to side opposite the direction of the user's turning head, providing a sense to the user that they sitting in front of a huge screen and able to pan back and forth across it. When the user of the device 10 is watching a video, the user can look around the display and focus on any part desired by the user. A portable hard drive or USB stick can connect to the device 10 through USB and the user can view files such as pictures or movies on that hard drive or USB stick. Voice commands work exceptionally well because of the closed environment of the inside of the mask 12. It is anticipated that special voice command applications will be utilized by the mask 12.

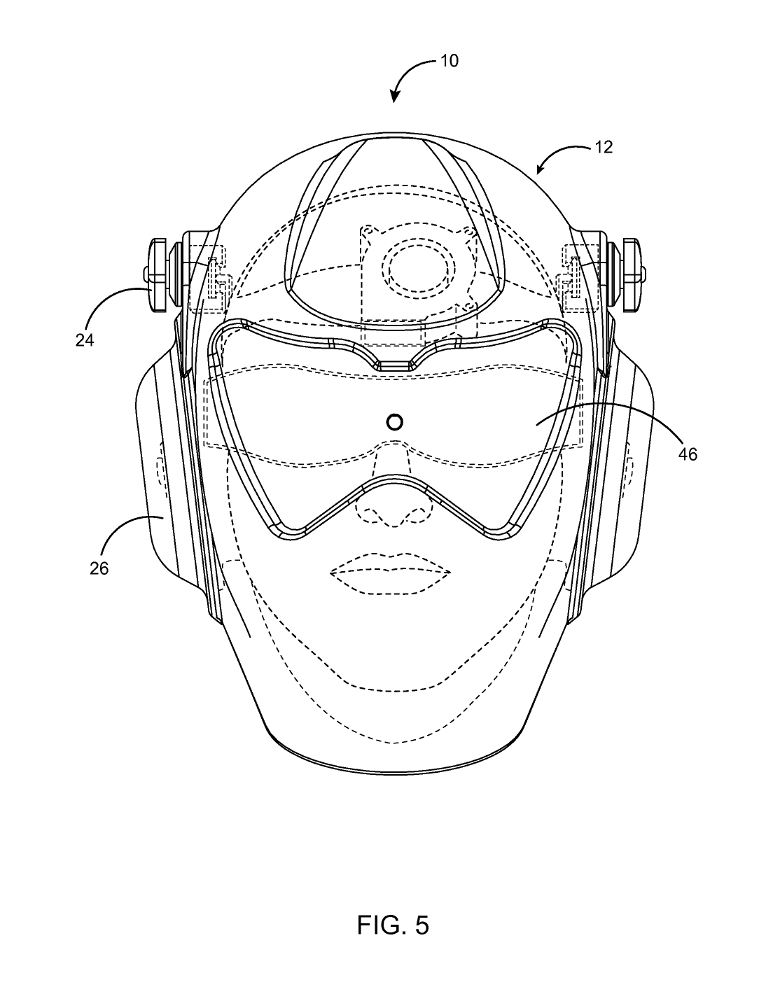

FIG. 5 illustrates a front transparent view of the preferred embodiment of the portable electronic device 10. The mask 12 provides other benefits such as it assists people with learning disorders such as A.D.D (Attention Deficit Disorder) and A.D.H.D (Attention Deficit Hyperactivity Disorder). The mask 12 helps the user to focus on educational or instructional activity without external distractions. Further, the mask 12 may be useful in managing individual behavior in classrooms. The mask 12 provides both audio and video information free from harmful radiation and vertigo caused by inflammation of the nerves of the inner ear. The mask 12 is manufactured from materials that can be recycled after use.

In an alternate embodiment of the present invention, the mask 12 includes a motion actuator for games. The motion actuator provides a feel of vibration to the user during a game event. For example, if a volcano erupts in the game, then the user may feel a vibration from the mask 12.

In one embodiment, headgear knob 24 points inward instead of outwards. In a new preferred embodiment the device 10 arrives from the factory preset to have the screen locked down. By turning the headgear knob 24 the user can loosen it just as one would do with a welding mask. When the gear knob 24 is facing inwards on the mask 12 instead of outwards, the user may need a tool such a screwdriver to access the headgear knob 24 and turn it.

In another embodiment of the present invention, the mask 12 includes eye tracking. When eye tracking, the display moves up and down with eye movement. The display adjusts itself depending on the movement of eye to provide a clear vision outside the mask 12. The eye tracker according to the preferred embodiment of the invention measures the point of gaze, allowing a computer to sense where the user is looking. This information is useful in a variety of contexts such as user interface navigation. By sensing the user's gaze, a computer can change the information displayed on a screen, bring additional details to attention, etc.

In another embodiment of the present invention, the mask 12 includes wireless mirroring as a means for getting the signal from a mobile phone or a tablet and into the mask 12. For example, Apple AirPlay is a mirroring technology over Wi-Fi. There are some third party companies who have AirPlay licensed hardware designs for mirroring with Apple devices and Android devices. On the opposite side of the table from Apple, there is DLNA, which is an open source HD mirroring solution that can be streamed over Wi-Fi, which runs on Android OS.

The mask 12 is designed so that it creates a private environment for a user providing comfort to a user. The mask 12 provides high quality sound and picture with distinct features for on screen controls of the pair of OLED displays 46 that include clarity, focus, 2D-3D, brightness, contrast, hue, color saturation etc. The additional features of the display mask 12 are blocking out light, providing necessary ventilation, and head tracking In method of head tracking, the pair of OLED displays 46 may also be used with tracking sensors that allow changes of angle and orientation to be recorded. When such data is available in the system computer, it can be used to generate the appropriate computer-generated imagery (CGI) for the angle-of-look at the particular time. This allows the user to look around a virtual reality environment simply by moving the head without the need for a separate controller to change the angle of the imagery. Further, the mask 12 includes the pair of headphones 26 with Dolby digital surround sound that helps in providing high quality sound to the user. The mask may also employ noise-cancelling algorithms and software as are known in the art to use the microphone and headphones in combination to further reduce outside ambient sound. The speakers may be flat panel, exciter based, infra-bass and/or noise cancelling speakers. It is noted that the mask 12 may be used as a display in connection with a PC or game console that is running virtual reality software. This will allow users with powerful PCs or the latest game console to retain a benefit of the mask 12 by relying on the changing (and generally over the years, more powerful) specifications of the PC or game console.

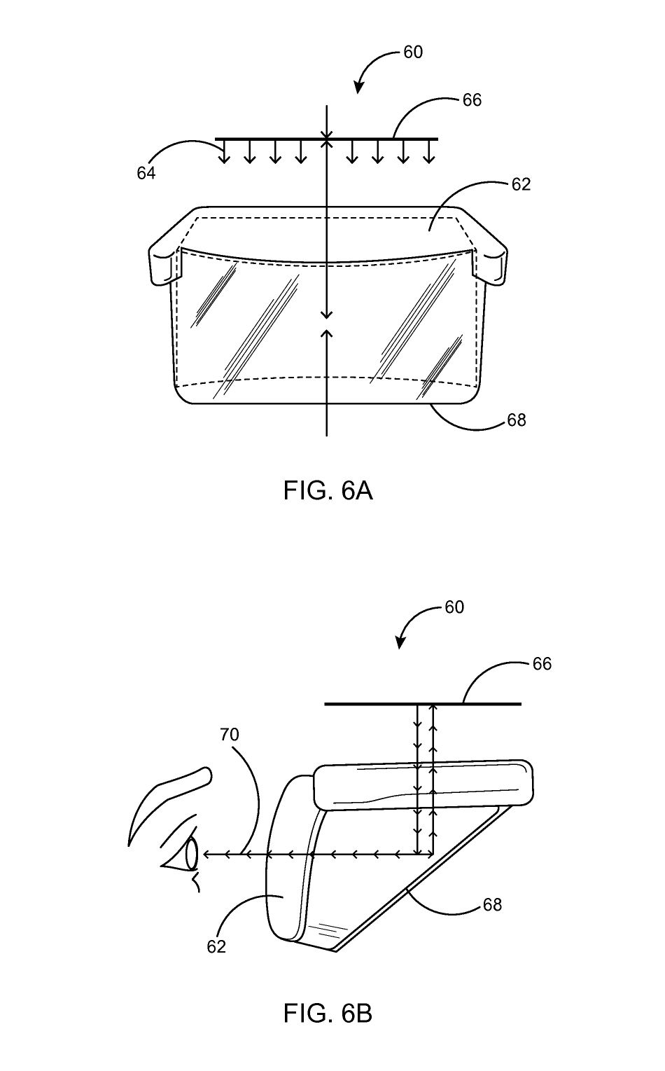

In alternate embodiments, FIGS. 6A and 6B illustrate the display 60 that may be an angled OLED display 68. FIG. 6A illustrates the front view of a concave curved mirror 70 while looking through a magnification lens. The flat panel OLED display 68 is located horizontally above an acrylic lens 64. A concave mirror 70 is fixed at an angle of 45 degrees inside the acrylic lens 64. The concave mirror 70 located inside of an acrylic lens 64 reflects the angled OLED display 68 back to the user's eye thereby creating a curved wrap around Imax®-theater-like image (shown as 72 in FIG. 6B). The curved mirror 70 reflects a wrap around angled OLED display 68 that when magnified is equal to a 100″ screen as viewed from 4 meters away. The direction of reflection of OLED is shown as 66 in FIG. 6A. The top surface of the lens 64 is flat and clear. angled OLED display and lens 64 are located inside of a display housing. The user's eyes see OLED display 64 through a magnifying lens and the image is reflected off a concave mirror 70 inside the lens 64 (shown in FIG. 6B).

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A portable electronic device for providing audio/video information, the portable electronic device comprising:
a mask having a front surface, a back surface, a right surface and a left surface;
a pair of high-resolution OLED displays at the back surface of the mask, each of the OLED displays being provided with high resolution and auto focus adjustment;
a micro digital camera lens at the front surface of the mask to provide vision outside the mask without removal of the mask, the micro digital camera lens being adaptable to be turned to night vision mode;
a touch pad embedded at the front surface of the mask for mouse control;
at least one built-in air vent and filter at the front surface of the mask to provide circulation of fresh exterior air to the back surface of the mask;
a blower on the back surface of the mask to allow circulation of exterior air across the back surface of the mask through the at least one built-in air vent;
a printed circuit board (PCB) module having a built-in memory;
a wireless remote to control the pair of OLED displays;
a pair of headphones in communication with the PCB;
a blower switch to turn on and turn off the blower;
a plurality of rechargeable lithium ion batteries for powering the PCB module and the pair of OLED displays;
an adjustable headgear with a pair of headgear knobs at the front surface of the mask to allow the adjustment and removal of mask;
a wireless microphone built into the PCB display system to allow verbal communication, the wireless microphone being adaptable to allow other online communication without the removal of the mask; and
a blower cover located at the front surface of the mask to provide protective covering for the blower;
whereby the device provides high quality audio and/or video information in a private environment to a user wearing the mask.

2. The portable electronic device of claim 1 wherein the pair of OLED displays is transparent when the device is in turned off condition.

3. The portable electronic device of claim 1 wherein the pair of OLED displays turns dark and videos project on an inner surface mask through the pair of OLED displays.

4. The portable electronic device of claim 1 wherein a headgear pad is used for securing the headgear in position without causing dislocation of the headgear.

5. A portable electronic device for providing audio/video information for providing education and entertainment, the portable electronic device comprising:
a mask having a front surface, a back surface, a right surface and a left surface;
a pair of high-resolution OLED displays at the back surface of the mask, each of the OLED displays being provided with high resolution and auto focus adjustment;
a micro digital camera lens at the front surface of the mask to provide vision outside the mask without removal of the mask, the micro digital camera lens being adaptable to be turned to night vision mode;
a touch pad embedded at the front surface of the mask for mouse control;
at least one built-in air vent and filter at the front surface of the mask to provide circulation of fresh exterior air to the back surface of the mask;
a blower on the back surface of the mask to allow circulation of exterior air across the back surface of the mask through the at least one built-in air vent;
a printed circuit board (PCB) module having a built-in memory;
a wireless remote to control the plurality of OLED displays;
a pair of headphones in communication with the printed circuit board;
a power switch to turn on and turn off the pair of OLED displays and the PCB module;
a blower switch to turn on and turn off the blower;
a plurality of rechargeable lithium ion batteries for powering the PCB module and the pair of OLED displays;
an adjustable headgear with a pair of headgear knobs at the front surface of the mask to allow the adjustment and removal of the mask;
a wireless microphone built into PCB mounted to display system to allow verbal communication, the wireless microphone being adaptable to allow other online communication without the removal of the mask; and
a blower cover located at the front surface of the mask to provide protective covering for the blower;
whereby the device provides high quality audio and/or video information in a private environment to a user wearing the mask.

6. The portable electronic device of claim 5 wherein the microphone is used for verbal online communication.

7. The portable electronic device of claim 5 wherein the pair of headphones helps to provide high quality sound.

8. A portable electronic device for providing audio/video information in a comfortable and private environment with high quality audio and video effects, the portable electronic device comprising:
a mask having a front surface, a back surface, a right surface and a left surface;
a pair of high-resolution OLED displays at the back surface of the mask, each of the OLED displays being provided with high resolution and auto focus adjustment;
a micro digital camera lens at the front surface of the mask to provide vision outside the mask without removal of the mask, the micro digital camera lens being adaptable to be turned to night vision mode;
a touch pad embedded at the front surface of the mask for cursor control;
at least one built-in air vent and filter at the front surface of the mask to provide circulation of fresh exterior air to the back surface of the mask;
a blower on the back surface of the mask to allow circulation of exterior air across the back surface of the mask through the at least one built-in air vent;
a PCB module having a built-in memory;
a wireless remote to control the pair of OLED displays;
a pair of headphones in communication with the PCB;
a power switch to turn on and turn off the pair of OLED displays and the PCB module;
a blower switch to turn on and turn off the blower;
a plurality of rechargeable lithium ion batteries for powering the PCB module and the pair of OLED displays;
an adjustable headgear with a pair of headgear knobs at the front surface of the mask to allow the adjustment and removal of mask;
a headgear pad at the back surface of the mask to secure the headgear in position;
a wireless microphone built into PCB mounted to display system to allow verbal communication, the wireless microphone being adaptable to allow other online communication without the removal of the mask; and
a blower cover located at the front surface of the mask to provide protective covering for the blower;
whereby the device provides high quality audio and/or video information in a private environment to a user wearing the mask.

9. The portable electronic device of claim 8 wherein the PCB has a built-in memory available for downloading videos.

10. The portable electronic device of claim 8 wherein portable electronic device may include an audio/video port connecting to the PCB module for allowing the user to display video selected from the group consisting of: movies, video games, instructional or educational videos, online books, and meditation videos.

11. The portable electronic device of claim 8 wherein the portable electronic device utilizes a 3-axis accelerometer to measure head tracking for movies.

12. The portable electronic device of claim 8 wherein the pair of OLED displays used may be curved displays.

13. The portable electronic device of claim 8 wherein the portable electronic device download videos can be selected from a group comprising of: movies, video games, instructional or educational videos, online books, meditation videos, etc.

14. The portable electronic device of claim 8 wherein the portable electronic device operates via Android operating system.

15. The portable electronic device of claim 8 wherein the portable electronic device is charged through induction using a charging pad.
